(19) United States
(12) Patent Application Publication
(10) Pub. No.: US 2026/0361859 A1
(43) Pub. Date: Nov. 12, 2026

(54) VIDEO CODING METHOD AND DEVICE FOR ADAPTIVELY GENERATING MOST PROBABLE MODE (MPM) LIST

(71) Applicants: Hyundai Motor Company, Seoul (KR); Kia Corporation, Seoul (KR); RESEARCH & BUSINESS FOUNDATION SUNGKYUNKWAN UNIVERSITY, Suwon-si, Gyeonggi-do (KR)

(72) Inventors: Byeung Woo JEON, Seongnam-si, Gyeonggi-do (KR); Jee Yoon PARK, Seoul (KR); Jee Hwan LEE, Gwacheon-si, Gyeonggi-do (KR); Yong Seong KIM, Suwon-si Gyeonggi-do (KR); Jin HEO, Yongin-si, Gyeonggi-do (KR); Seung Wook PARK, Yongin-si, Gyeonggi-do (KR)

(21) Appl. No.: 19/135,121

(22) PCT Filed: Oct. 27, 2023
(86) PCT No.: PCT/KR2023/016848

§ 371 Date: Jun. 3, 2025

(30) Foreign Application Priority Data
Dec. 6, 2022 (KR) 10-2022-0168825
Oct. 24, 2023 (KR) 10-2023-0143180

(51) Int. Cl. H04N 19/11; H04N 19/136; H04N 19/176; H04N 19/70

(52) U.S. Cl. CPC H04N 19/11; H04N 19/136; H04N 19/176; H04N 19/70

(57) ABSTRACT

A method and an apparatus are disclosed for video coding for adaptively generating a most probable mode list (MPM list). In the disclosed embodiments, a video decoding device obtains a prediction mode of a base block of the current block and checks the prediction mode of the base block. When the prediction mode of the base block is an irregular intra mode, the video decoding device obtains a switching method for the base block, and switches the base block to a block having a regular intra-prediction mode according to the switching method. The video decoding device generates a most probable mode list (MPM list) of the current block by using the regular intra-prediction mode of a switched base block.

### TECHNICAL FIELD

The present disclosure relates to a video coding method and an apparatus for adaptively generating a most probable mode list (MPM list).

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Intra prediction utilizes pixel information within the common picture to predict pixel values for the current block to be encoded. With the intra prediction, one of many intra-prediction modes may be selected and used to predict the current block in accord with the features of the video. The encoder selects and then uses one of the many intra-prediction modes to encode the current block. Thereafter, the encoder may pass information about that mode to the decoder.

HEVC technology utilizes a total of 35 intra-prediction modes for intra prediction, including thirty-three angular modes with directionality and two non-angular modes without directionality. However, as the spatial resolution of videos increases from 720×480 to 2048×1024 or 8192×4096, the size of the prediction block unit becomes larger and larger, increasing the need to add more diverse intra-prediction modes. As illustrated in FIG. 3A, the VVC technique utilizes 65 prediction modes which are further subdivided for intra prediction, allowing for a greater variety of prediction directions than in the prior art.

Meanwhile, for the luma channel, the most probable mode (MPM) is used for efficient encoding/decoding of 67 intra-prediction modes (IPMs) on a per-CU basis, including planar and DC modes which are non-angular prediction modes. Based on the characteristic similarity between the prediction modes of neighbor blocks when blocks are encoded in intra-prediction mode, the MPM technique selects 6 MPM candidates based on the modes used by the neighbor blocks of the current block, its neighboring modes, and statistically frequent modes used. The group of six MPM candidates is called the MPM list. If the intra-prediction mode of the current block is included in the MPM list, the encoder encodes the MPM index that indicates the prediction mode in the MPM list. On the other hand, if the intra-prediction mode of the current block is not included in the MPM list, the encoder encodes the intra-prediction mode of the current block by using an MPM remainder which is composed of the IPMs excluding the 6 MPM candidates.

A conventional MPM technique, when generating an MPM list, uses just a prediction mode of a block including pixels adjacent to the bottom-left side of the current block and a block including pixels adjacent to the top-right side, which is referred to as a ‘base block’ hereinafter. In this case, if the prediction mode of the base block is an irregular intra-prediction mode or irregular intra mode, the encoder may not be able to finally select one of the prediction modes in the MPM list as the prediction mode of the current block. Therefore, to increase video coding efficiency and enhance video quality, there is a need for a method of efficiently generating an MPM list when the prediction mode of the base block is the irregular intra mode.

### DISCLOSURE

### Technical Problem

The present disclosure seeks to provide a video coding method and an apparatus that, when generating an MPM list of a current block and where a base block is in an irregular intra-prediction mode or irregular intra mode, switch the base block to a block having a regular intra-prediction mode and then use the switched base block for adaptively generating the MPM list.

### Technical Solution

At least one aspect of the present disclosure provides a method of reconstructing a current block by a video decoding apparatus. The method including obtaining a prediction mode of a base block of the current block. The base block is a block comprising pixels positioned to a left side of a bottom-left pixel of the current block or a block comprising pixels positioned to a top side of a top-right pixel of the current block. The method also including checking the prediction mode of the base block. When the prediction mode of the base block is an irregular intra mode, the method further includes obtaining a switching method for the base block, switching the base block to a block having a regular intra-prediction mode according to the switching method, and generating a most probable mode list (MPM list) of the current block by using the regular intra-prediction mode of a switched base block.

Another aspect of the present disclosure provides a method of encoding a current block by a video encoding apparatus. The method includes obtaining a prediction mode of a base block of the current block. The base block is a block comprising pixels positioned to a left side of a bottom-left pixel of the current block or a block comprising pixels positioned to a top side of a top-right pixel of the current block. The method also includes checking the prediction mode of the base block. When the prediction mode of the base block is an irregular intra mode, the method further includes determining a switching method for the base block, switching the base block to a block having a regular intra-prediction mode according to the switching method, and generating a most probable mode list (MPM list) of the current block by using the regular intra-prediction mode of a switched base block.

Yet another aspect of the present disclosure provides a computer-readable recording medium storing a bitstream generated by a video encoding method. The video encoding method includes obtaining a prediction mode of a base block of a current block. The base block is a block comprising pixels positioned to a left side of a bottom-left pixel of the current block or a block comprising pixels positioned to a top side of a top-right pixel of the current block. The video encoding also method includes checking the prediction mode of the base block. When the prediction mode of the base block is an irregular intra mode, the video encoding method further includes determining a switching method for the base block, switching the base block to a block having a regular intra-prediction mode according to the switching method, and generating a most probable mode list (MPM list) of the current block by using the regular intra-prediction mode of a switched base block.

### Advantageous Effects

As described above, the present disclosure provides a video coding method and an apparatus that, when generating an MPM list of a current block and where a base block is in an irregular intra-prediction mode or irregular intra mode, switch the base block to a block having a regular intra-prediction mode and then use the switched base block for adaptively generating the MPM list. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating the pixels utilized in the construction of the most probable mode list (MPM list).

FIG. 7 is a diagram illustrating the generation of an MPM list when the mode of a block including pixel Lis an irregular intra mode.

FIG. 8 is a diagram illustrating the switching of a base block when the mode of the block including pixel L is an irregular intra mode, according to at least one embodiment of the present disclosure.

FIG. 9 is a diagram illustrating the construction of an MPM list when the mode of a block including pixel A is an irregular intra mode.

FIG. 10 is a diagram illustrating the switching of a base block when the mode of the block including pixel A is an irregular intra mode, according to at least one embodiment of the present disclosure.

FIGS. 11A to 11D are diagrams illustrating predetermined neighboring pixel searching orders, according to at least one embodiment of the present disclosure.

FIG. 12 is a diagram illustrating the switching of a base block by using a neighboring pixel searching order, according to at least one embodiment of the present disclosure.

FIG. 13 is a diagram illustrating the switching of a base block by using a neighboring pixel searching order, according to another embodiment of the present disclosure.

FIG. 14 is a diagram illustrating the switching of a base block by using adjacency lengths, according to at least one embodiment of the present disclosure.

FIG. 15 is a diagram illustrating the switching of a base block by using adjacency lengths, according to another embodiment of the present disclosure.

FIG. 16 is a diagram illustrating the switching of a base block by using areas, according to at least one embodiment of the present disclosure.

FIG. 17 is a diagram illustrating the switching of a base block by using areas, according to another embodiment of the present disclosure.

FIG. 18 is a diagram illustrating the switching of a base block by using aspect ratios, according to at least one embodiment of the present disclosure.

FIG. 19 is a diagram illustrating the switching of a base block by using aspect ratios, according to another embodiment of the present disclosure.

FIG. 20 is a flowchart of a method of encoding the current block by a video encoding apparatus, according to at least one embodiment of the present disclosure.

FIG. 21 is a flowchart of a method of reconstructing the current block by a video decoding apparatus, according to at least one embodiment of the present disclosure.

FIG. 22 is a flowchart of a method of encoding the current block by the video encoding apparatus, according to another embodiment of the present disclosure.

FIG. 23 is a flowchart of a method of reconstructing the current block by the video decoding apparatus, according to another embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

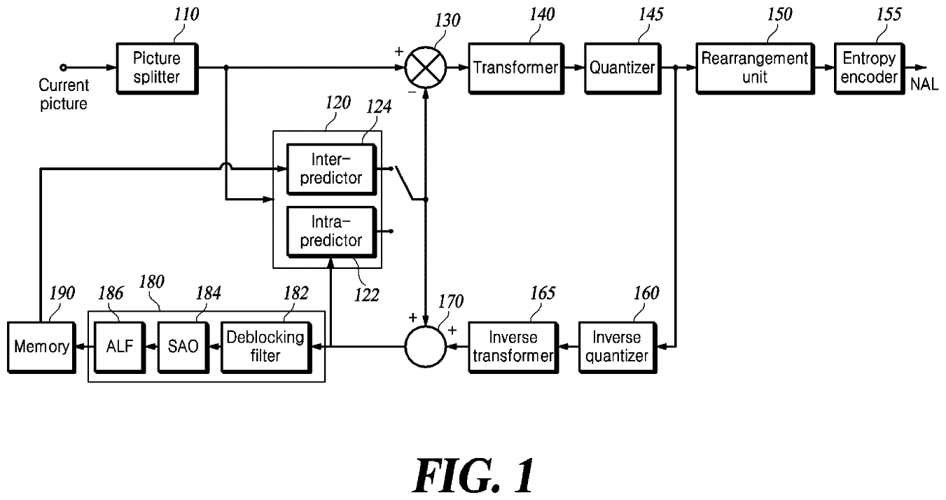

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

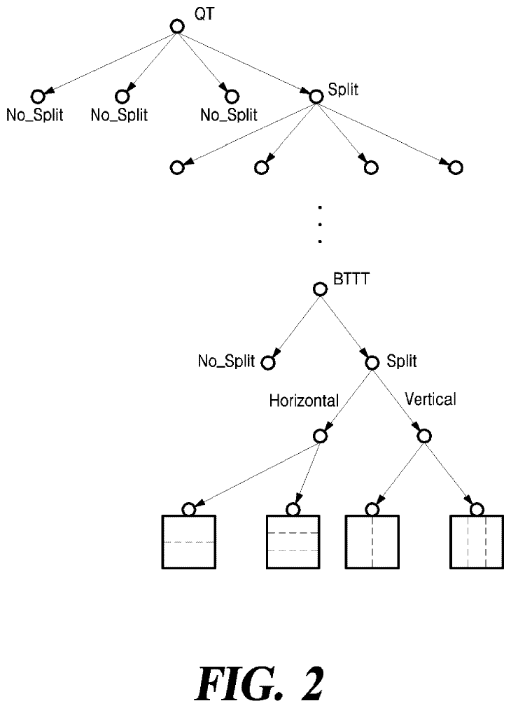

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

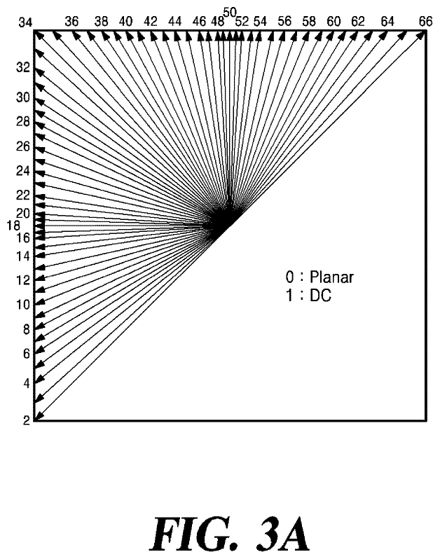

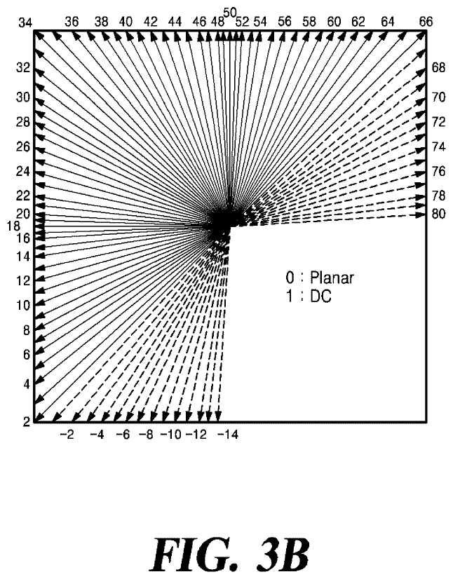

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

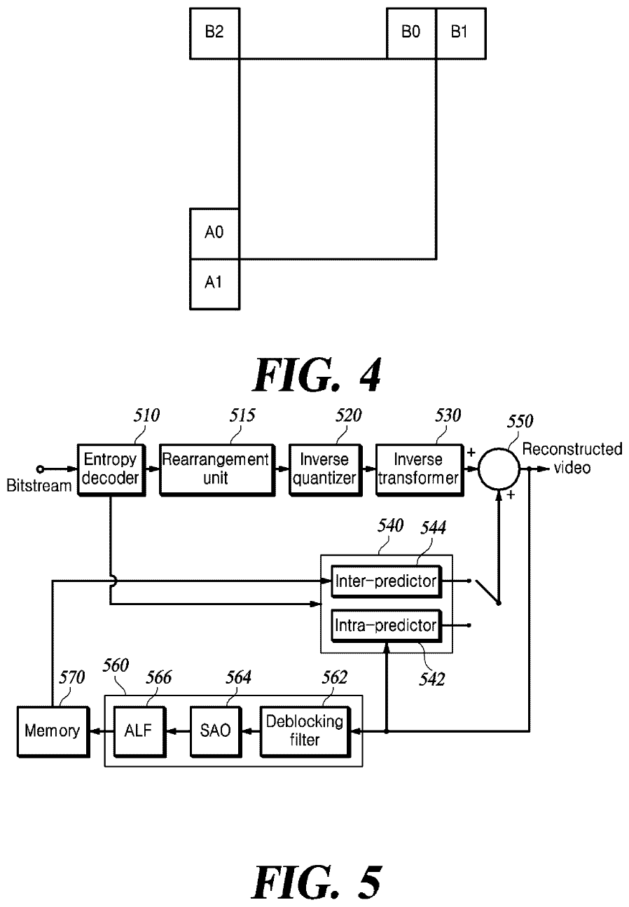

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that, when generating a most probable mode list (MPM list) of the current block and where a base block is in an irregular intra-prediction mode or irregular intra mode, switch the base block to a block having a regular intra-prediction mode and then use the switched base block for adaptively generating the MPM list.

The following embodiments may be performed by the intra predictor 122 in the video encoding device.

The following embodiments may also be performed by intra predictor 542 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Intra-Prediction Mode and Most Probable Mode (MPM) Technique

As described above, in intra prediction, a predictor of the luma channel may be generated based on 67 intra-prediction modes (IPMs). 67 IPMs means 67 intra-prediction modes that may be signaled among prediction modes −14 to 80, including non-angular prediction modes of planar mode and DC mode. Meanwhile, prediction modes −14 to −1 and 67 to 80 are called wide angular intra prediction modes (WAIP modes) which are larger angular modes signaled according to the aspect ratio of the block.

Hereinafter, regular intra-prediction mode or regular intra mode refers to 67 intra-prediction modes that may be signaled among prediction mode −14 to prediction mode 80 depending on the block aspect ratio, the 67 intra-prediction modes including non-angular intra-prediction modes of planar mode and DC mode. A set of regular intra-prediction modes refers to a set of the above-described 67 prediction modes. In addition, irregular intra-prediction mode or irregular intra mode denotes a prediction mode that is not included in the set of regular intra-prediction modes. A set of irregular intra modes may include intra block copy (IBC), palette mode, Matrix-weighted Intra Prediction (MIP), Block-based Delta Pulse Code Modulation (BDPCM), and inter prediction.

When generating a predictor by using one of the 67 prediction modes, the video encoding apparatus signals the prediction mode by using the most probable mode (MPM) to efficiently transmit the prediction mode information.

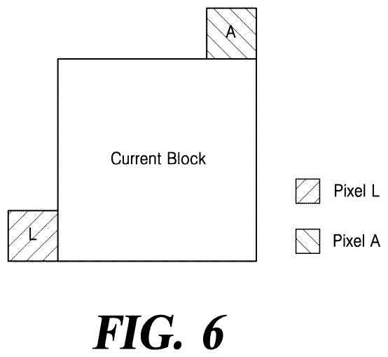

MPM takes advantage of the property that, when blocks are encoded in intra-prediction mode, the prediction modes of neighbor blocks are likely to be similar to each other. As illustrated in FIG. 6, base blocks are defined by the blocks inclusive of pixel L on the left of the bottom-left pixel of the current block and pixel A on the top of the top-right pixel of the current block. Additionally, one defines modeL and modeA by the prediction modes of the base blocks being respectively inclusive of pixel L and pixel A. An MPM list may be generated by selecting six MPM candidates based on model and modeA. If modeL or modeA is not a regular intra-prediction mode, i.e., if modeL or modeA is an irregular intra mode, or if pixel L or pixel A is not usable because the current block is located at the boundary of a CTU (Coding Tree Unit), tile, slice, sub-picture, picture, or the like, the base block including the unusable pixel L or pixel A has its prediction mode replaced by one of the set of regular intra-prediction modes. For example, if model or modeA is one of IBC, palette, MIP, inter prediction, or if the current block is located on the boundary of a CTU, tile, slice, sub-picture, picture, or the like, and pixel L or pixel A is not usable, then the prediction mode of the base block including the unusable pixel L or pixel A is considered to be planar. If modeL or modeA is BDPCM, the modeL or modeA is replaced by one of the set of regular intra-prediction modes, which is a horizontal mode of mode 18 or a vertical mode of mode 50 corresponding to the mode direction of BDPCM. The MPM list may then be generated according to the following MPM list generation algorithm (hereinafter ‘generation algorithm’).

First, if model and modeA are the same, and when model is greater than INTRA_DC, selected as MPM candidates are {Planar, modeL, 2+((modeL+61) % 64), 2+((modeL−1) % 64), 2+((modeL+60) % 64), 2+(modeL % 64)}.

Next, if modeL and modeA are not the same, and when either model or modeA is greater than INTRA_DC, the MPM candidates are organized as follows. Here, minAB=Min (modeL, modeA), maxAB=Max (modeL, modeA).

If both model and modeA are greater than INTRA_DC, and when maxAB−minAB=1, selected as MPM candidates are {Planar, modeL, modeA, 2+((minAB+61) % 64), 2+((maxAB−1) % 64), 2+((minAB+60) % 64)}.

If both model and modeA are greater than INTRA_DC, and when maxAB−minAB≥62, selected as MPM candidates are {Planar, modeL, modeA, 2+((minAB−1) % 64), 2+((maxAB+61) % 64), 2+(minAB % 64)}.

If both model and modeA are greater than INTRA_DC, and when maxAB−minAB=2, selected as MPM candidates are {Planar, modeL, modeA, 2+((minAB−1) % 64), 2+((minAB+61) % 64), 2+((maxAB−1) % 64)}.

If both model and modeA are greater than INTRA_DC and when 2<maxAB−minAB<62, selected as MPM candidates are {Planar, modeL, modeA, 2+((minAB+61) % 64), 2+((minAB−1) % 64), 2+((maxAB+61) % 64)}.

If modeL and modeA are not the same, and when one of model and modeA is greater than INTRA_DC, selected as MPM candidates are {Planar, maxAB, 2+((maxAB+61) % 64), 2+((maxAB−1) % 64), 2+((maxAB+60) % 64), 2+(maxAB % 64)}.

Further, if both modeL and modeA are equal to or less than INTRA_DC, then selected as MPM candidates are {Planar, INTRA_DC, INTRA_ANGULAR50, INTRA_ANGULAR18, INTRA_ANGULAR46, INTRA_ANGULAR54}.

Meanwhile, if MPM is utilized, the video decoding apparatus parses the intra-prediction mode of the current block as shown in Table 1.

TABLE 1

```
if( intra_luma_mpm_flag ) {
  if( intra_luma_ref_idx = = 0)
    intra_luma_not_planar_flag
  if( intra_luma_not_planar_flag )
    intra_luma_mpm_idx
}
```

The video decoding apparatus decodes the intra_luma_mpm_flag to determine whether the MPM list is to be used. If intra_luma_mpm_flag is true and intra_luma_ref_idx is 0, intra_luma_not_planar_flag, a flag indicating whether planar mode is to be used, may be signaled from the video encoding apparatus to the video decoding apparatus. The first element in the MPM list, MPM index 0, is in planar mode and is therefore signaled with the intra_luma_not_planar_flag. If intra_luma_not_planar_flag is false, the intra-prediction mode is set to planar mode. On the other hand, if intra_luma_not_planar_flag is true, intra_luma_mpm_idx may be additionally signaled to indicate MPM indices 1-5. If intra_luma_not_planar_flag is absent, it may be inferred to be true.

On the other hand, if intra_luma_ref_idx is non-zero, the planar mode is not to be used. Therefore, intra_luma_not_planar_flag is not sent and is assumed to be true. Additionally, since intra_luma_not_planar_flag is true, intra_luma_mpm_idx may be signaled.

The following embodiments are described with reference to the video decoding apparatus but may be implemented in the same or similar manner by the video encoding apparatus.

### II. Embodiments of the Present Disclosure

The problem with the fixed positions at L and A of the pixels for base block determination, as in the example of FIG. 6, is the failure to use prediction information from blocks other than those including pixel L and pixel A in the MPM list generation process. As a result, one cannot take advantage of the property that the current block has a high probability of using the mode in the MPM list, resulting in a decrease in video coding efficiency or a degradation of video quality. When the mode of the base block is an irregular intra mode, the present disclosure can resolve the prior art problem by adaptively turning the irregular intra mode into a regular intra-prediction mode to efficiently generate the MPM list.

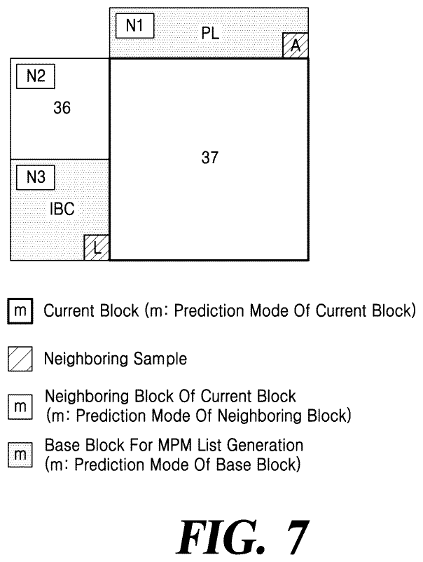

FIG. 7 is a diagram illustrating the generation of an MPM list when the mode of a block including pixel Lis an irregular intra mode.

As illustrated in FIG. 7, blocks N3 and N1 including pixels L and A may be determined to be the base blocks for generating the MPM list. Since the mode of block N3 is an IBC (intra block copy) included in the set of irregular intra modes, the video decoding apparatus substitutes the IBC to turn the mode of block N3 into planar mode as described above. Since all prediction modes of the base blocks are not angular modes, the generation algorithm generates the MPM list of {0 (Planar), 1 (DC), 50 (Vertical), 18 (Horizontal), 46, 54}. However, if the current block selects mode 37, which is not in the MPM list, many bits need to be consumed to transmit that mode 37.

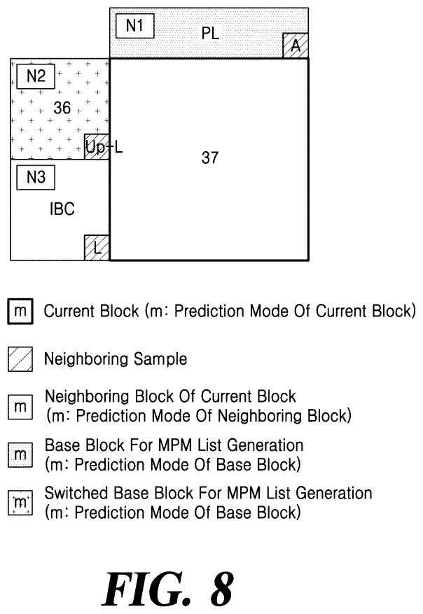

FIG. 8 is a diagram illustrating the switching of a base block when the mode of the block including pixel L is an irregular intra mode, according to at least one embodiment of the present disclosure.

In this case, as in the example of FIG. 8, switching the pixel for determining the base block from pixel L to pixel Up-L to switch the base block to an N2 block, or switching the very base block to N2 block may cause the video decoding apparatus to use mode 36, which is the prediction mode of N2 block and is included in the set of regular intra-prediction modes in generating the MPM list. Since one of the modes of the base blocks is an angular mode, the generation algorithm generates the MPM list of {0 (Planar), 36, 35, 37, 34, 38}. Therefore, mode 37 selected by the current block is present in the MPM list, which can reduce the bits to transmit that mode 37. The switching of the base block satisfies the property that the mode in the MPM list is used by the current block with a high probability, which can increase coding efficiency and enhance video quality.

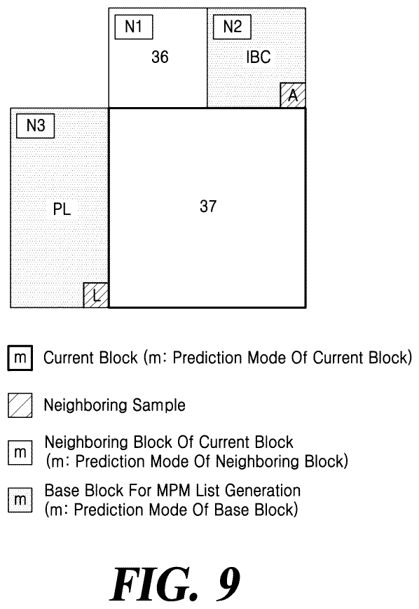

FIG. 9 is a diagram illustrating the construction of an MPM list when the mode of a block including pixel A is an irregular intra mode.

The example of FIG. 9 illustrates an example where, unlike the example of FIG. 7, the prediction mode of the N2 block including pixel A is an irregular intra mode. Since the prediction mode of block N2 is IBC, the video decoding apparatus substitutes IBC to turn the mode of block N2 into planar mode as described above. Since all prediction modes of the base blocks are not angular modes, the generation algorithm generates the MPM list of {0 (Planar), 1 (DC), 50 (Vertical), 18 (Horizontal), 46, 54}. However, similar to the example in FIG. 7, if the current block, e.g., based on the MPM remainder, selects mode 37 that is not in the MPM list, many bits need to be consumed to transmit mode 37.

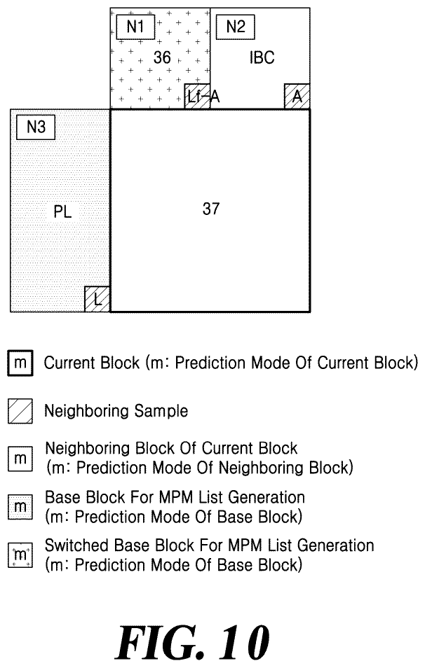

FIG. 10 is a diagram illustrating the switching of a base block when the mode of the block including pixel A is an irregular intra mode, according to at least one embodiment of the present disclosure.

In this case, switching the base block to an N1 block by changing the pixel for determining the base block from pixel A to pixel Lf-A, or switching the very base block to N1 block, as in the example of FIG. 10 may cause the video decoding apparatus to use the prediction mode of N1 block, mode 36, which is included in the set of regular intra-prediction modes in generating the MPM list. Since one of the modes of the base blocks is an angular mode, the generation algorithm generates the MPM list of {0 (Planar), 36, 35, 37, 34, 38}. Therefore, mode 37 selected by the current block is present in the MPM list, which can reduce the bits for transmitting mode 37. The example of FIG. 10 can bring the same effect as the example of FIG. 8.

To resolve the prior art problem in the process of generating an MPM list, the video decoding apparatus of the present disclosure sees if the mode of a base block is an irregular intra mode, and if positive, it adaptively changes the irregular intra mode to regular intra-prediction mode to efficiently generate the MPM list, as in the examples described above. For example, if a base block with an irregular intra-prediction mode exists during the MPM list generation process, the video decoding apparatus interchanges the base block by using reconstructed information of the current block and its neighbors, high-level information, and other signal information related to the operation of the present disclosure, thereby turning the mode of the switched block into a regular intra-prediction mode. The video decoding apparatus may generate the MPM list by using the prediction mode of the switched block.

The applicability of the present disclosure may be signaled or inferred. If, upon application of the present disclosure, multiple base block switching methods exist, the video decoding apparatus may parse one of the block switching methods and may proceed to interchange the base block according to the parsed method. Alternatively, the video decoding apparatus may proceed with the switching of the base block according to a predetermined method. The methods of determining whether the present disclosure is to be applied and the methods of determining the switching method for the base block may be combined in various ways.

For example, the applicability of the present disclosure may be signaled to a bitstream and a predetermined method may be used for the switching method for the base block. Alternatively, the applicability of the present disclosure may be inferred and the switching method for the base block may be signaled to the bitstream. Example implementations of the present disclosure are as follow.

Hereinafter, the term ‘adjacent’ refers to the spatial proximity of two objects, and the term ‘neighboring’, inclusive of ‘adjacent’ and the idea of one object refers to the presence of another object within a certain spatial distance of the one object.

### <Implementation 1> Switching Base Block

In this implementation, if the mode of the base block is an irregular intra mode, the video decoding apparatus interchanges the base block by taking into account the reconstructed information of the current block and its neighbors, thereby turning the mode of the switched block into regular intra-prediction mode. The existing MPM technology is based on the characteristic that the current block and its neighbor blocks have similar prediction modes. Therefore, the switching method for the base block also needs to consider the reconstructed information of the current block and its neighbor blocks, including the prediction modes of the neighbor blocks. The reconstructed information of the current block and its neighbors may include the width/height/area/aspect ratio/position of the current block, the current block's neighboring block's width/height/area/prediction mode/aspect ratio/position/distance to the current block, the current block's neighboring pixels' position/number/value/distance to the current block, or the like.

There are two specific methods of turning into the base block.

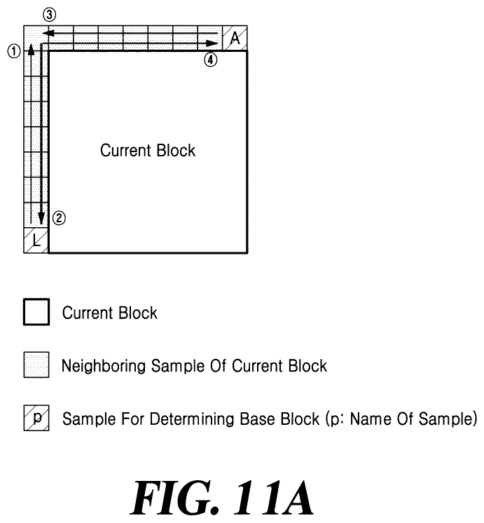

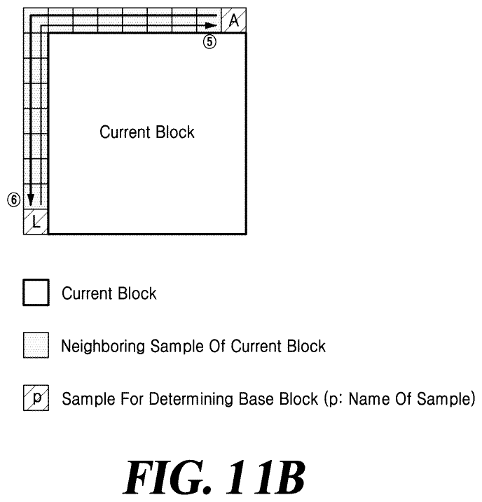

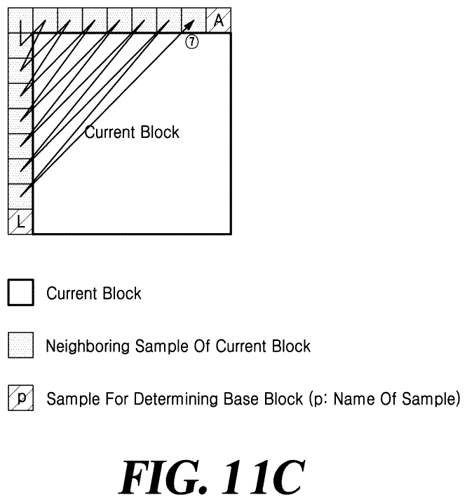

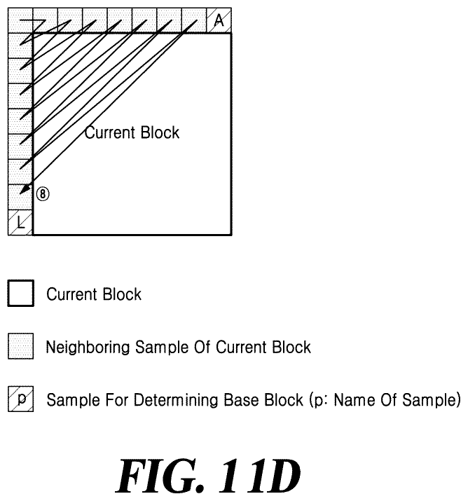

FIGS. 11A to 11D are diagrams illustrating predetermined neighboring pixel search orders, according to at least one embodiment of the present disclosure.

In the first method, if the prediction mode of a block including a pixel is determined to be a regular intra-prediction mode by performing a search according to the predetermined neighboring pixel searching orders as shown in the examples of FIGS. 11A to 11D, the block including the pixel is turned into a base block.

If the base block is on the left side of the current block, the base block may be searched in the following order: \textcircled{1} (bottom→top), \textcircled{2} (top→bottom), \textcircled{5} (bottom→top→right), \textcircled{7} (zigzag order beginning with the top-left pixel and away from pixel L), \textcircled{8} (zigzag order beginning with the top-left pixel and away from pixel A). If the base block is at the top of the current block, the base block may be searched in the following order: \textcircled{3} (right→left), \textcircled{4} (left→right), \textcircled{6} (right→left→bottom), \textcircled{7} (zigzag order beginning with the top-left pixel and away from pixel L), \textcircled{8} (zigzag order beginning with the top-left pixel and away from pixel A). In addition to the examples of FIGS. 11A to 11D, various preset neighboring pixel searching orders may be used.

In the second method, one of the reconstructed information items of the current block and its neighbors is utilized as a predetermined base block selection measure (e.g., adjacency length, area, aspect ratio, or the like.), and if the preset condition (e.g., maximum value) of each measure is met and the prediction mode of the block is regular intra-prediction mode, the block is turned into a base block.

Based on the above methods, if the mode of the base block is an irregular intra mode, the method of switching the base block to turn the mode of the block into a regular intra-prediction mode may be one of the following: (Implementation 1-1) searching the neighboring pixels of the current block according to the predetermined searching order, (Implementation 1-2) switching the base block to a block having a regular intra-prediction mode and whose adjacency length to the current block is the longest among the neighbor blocks, (Implementation 1-3) switching the base block to a block having a regular intra-prediction mode and whose area is the largest among the neighbor blocks, and (Implementation 1-4) switching the base block to a block having a regular intra-prediction mode and whose aspect ratio is equal to (or most similar to) that of the current block among the neighbor blocks.

In the example methods below, the neighbor blocks or pixels considered are all of the blocks adjacent to the current block. However, the range of neighbor blocks or pixels that may be considered may vary according to embodiments, including those blocks and pixels that are slightly further away.

Embodiments are each described in detail below.

### <Implementation 1-1> Method of Searching for Neighboring Pixels of the Current Block According to a Predetermined Searching Order

In this implementation, the video decoding apparatus searches the neighboring pixels of the current block according to the predetermined searching order, excluding the initial pixel, and switches the base block to a block including the first pixel predicted in the regular intra-prediction mode. At this time, the pixels included in the base block including pixel L or pixel A may be excluded from the search.

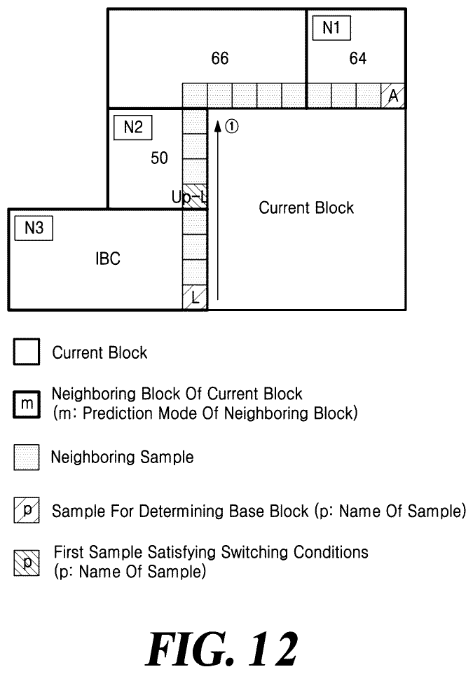

FIG. 12 is a diagram illustrating the switching of a base block by using a neighboring pixel search order, according to at least one embodiment of the present disclosure.

In one example case, as illustrated in FIG. 12, the prediction mode of a base block (a block including pixel L) adjacent to the left of the current block is an irregular intra mode. The video decoding apparatus may search the pixels adjacent to the left side of the current block in the order of \textcircled{1} (bottom to top) and may switch the base block to the searched block, thereby turning the mode of the block into a regular intra-prediction mode. In the example of FIG. 12, since the mode of N3 block including pixel L is IBC, the video decoding apparatus searches the neighboring pixels of the current block in the order of \textcircled{1} (bottom to top). At this time, since the prediction mode of N2 block including pixel Up-L is mode 50, and N2 block is the first block in the searching order, predicted according to the regular intra-prediction mode, the video decoding apparatus switches the base block to N2 block. After the base block is switched to N2 block, the MPM list may be generated by using mode 50, which is the prediction mode of N2 block.

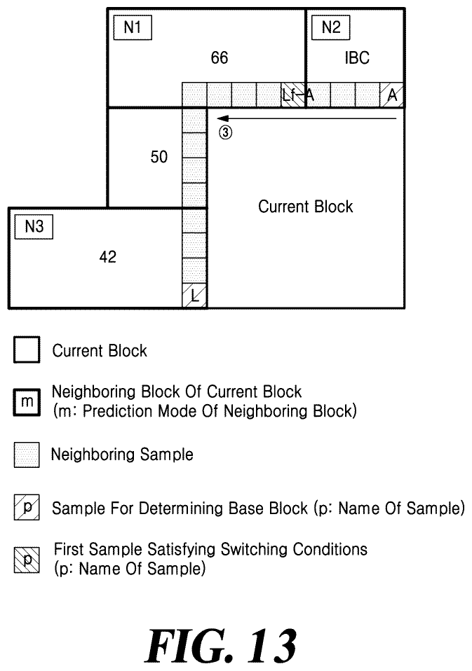

In another example case, as illustrated in FIG. 13, the prediction mode of a base block (a block including pixel A) adjacent to the top of the current block is an irregular intra mode. The video decoding apparatus may search the pixels adjacent to the top of the current block in the order of \textcircled{3} (right→left) and may switch the base block to the searched block, thereby turning the mode of the block to a regular intra-prediction mode. In the example of FIG. 13, since the mode of N2 block including pixel A is IBC, the video decoding apparatus searches the neighboring pixels of the current block in the order of \textcircled{3} (right→left). At this time, since the prediction mode of N1 block including pixel Lf-A is mode 66, and N1 block is the first block in the searching order, predicted according to the regular intra-prediction mode, the video decoding apparatus switches the base block to N1 block. After the base block is switched to N1 block, the MPM list may be generated by using mode 66 which is the prediction mode of N1 block.

### <Implementation 1-2> Method of Switching the Base Block to a Block Having a Regular Intra-Prediction Mode and Whose Adjacency Length to the Current Block is the Longest Among Neighbor Blocks

In this implementation, the video decoding apparatus may switch the base block to a block whose prediction mode is regular intra-prediction mode and whose adjacency length to the current block is the longest among the neighboring blocks of the current block. When interchanging the base block adjacent to the left side of the current block (the block including pixel L), the blocks around the left side are searched. The video decoding apparatus may measure the adjacency length between the right side of the left neighbor block and the left side of the current block, and may switch the base block to the block with the longest adjacency length. When switching the base block adjacent to the top of the current block (the block including pixel A), the blocks around the top are searched. The video decoding apparatus may measure the adjacency length between the bottom side of the top neighbor block and the top side of the current block, and may switch the base block to the block with the longest adjacency length.

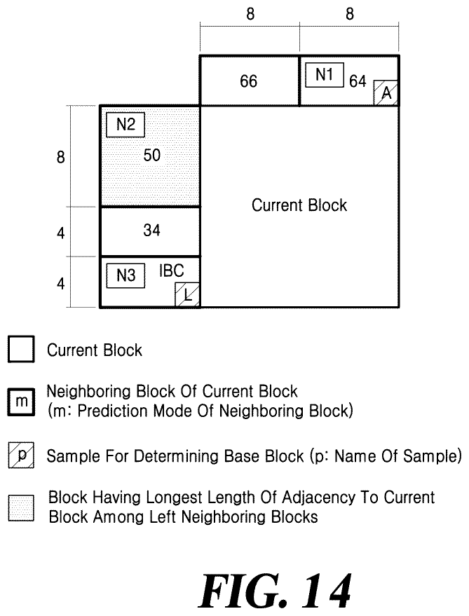

FIG. 14 is a diagram illustrating the switching of a base block by using adjacency lengths, according to at least one embodiment of the present disclosure.

In yet another example case, as illustrated in FIG. 14, the prediction mode of a base block (a block including pixel L) adjacent to the left side of the current block is an irregular intra mode. The video decoding apparatus may search for a block having the longest adjacency length to the current block among the neighbor blocks adjacent to the left side of the current block and may switch the base block to the searched block, thereby turning the mode of the block into a regular intra-prediction mode. In the example of FIG. 14, since the mode of N3 block including pixel L is IBC, the video decoding apparatus searches for the block with the longest adjacency length to the current block among the neighbor blocks adjacent to the left of the current block. At this time, the video decoding apparatus switches the base block to N2 block because N2 block has the longest adjacency length of 8 among the neighbor blocks adjacent to the left of the current block, and the prediction mode of N2 block is mode 50 which is included in the set of regular intra-prediction modes. After the base block is switched to N2 block, the MPM list may be generated by using mode 50 which is the prediction mode of N2 block.

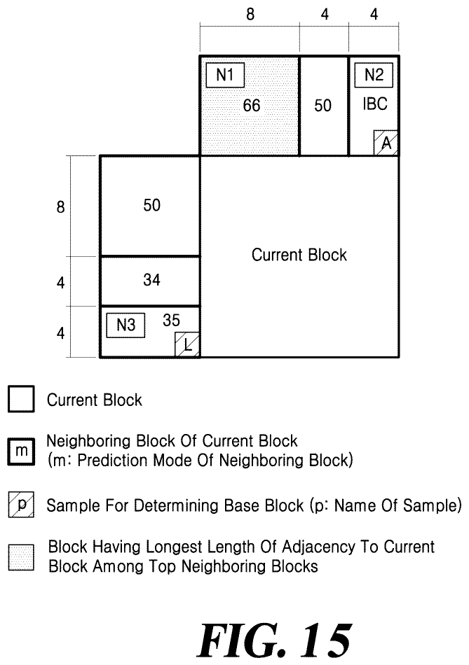

In yet another example case, as illustrated in FIG. 15, the prediction mode of a base block (the block including pixel A) adjacent to the top of the current block is an irregular intra mode. The video decoding apparatus may search for a block having the longest adjacency length to the current block among the neighbor blocks adjacent to the top of the current block, and may switch the base block to the searched block, thereby turning the mode of the block into a regular intra-prediction mode. In the example of FIG. 15, since the mode of the N2 block including pixel A is IBC, the video decoding apparatus searches for a block having the longest adjacency length to the current block among the neighbor blocks adjacent to the top of the current block. At this time, the video decoding apparatus switches the base block to N1 block because N1 block has the longest adjacency length of 8 among the neighbor blocks adjacent to the top of the current block, and the prediction mode of N1 block is mode 66 which is included in the set of regular intra-prediction modes. After the base block is switched to N1 block, the MPM list may be generated by using mode 66 which is the prediction mode of N1 block.

On the other hand, if two or more blocks have the same longest adjacency length, a base block may be selected to be one of the two or more blocks based on a preassigned priority. In this case, the priority may be based on the prediction mode of each block in an order such as {planar, DC, horizontal mode, vertical mode, . . . }, ascending order of the mode numbers, descending order of the mode numbers, or the like. Alternatively, the closer the block is to the top left, the higher the priority may be assigned. In addition to the above examples, one of the blocks with the longest adjacency length may be selected, based on a predefined rule.

### <Implementation 1-3> Method of Switching a Base Block to a Block Having a Regular Intra-Prediction Mode and Whose Area is the Largest Among Neighbor Blocks

In this implementation, the video decoding apparatus may switch the base block to a block having a prediction mode of regular intra-prediction mode and the largest area among the neighboring blocks of the current block. When switching the base block (the block including pixel L) adjacent to the left side of the current block, the video decoding apparatus may interchange the base block by searching the blocks neighboring the left side, and when switching the base block (the block including pixel A) adjacent to the top of the current block, the video decoding apparatus may interchange the base block by searching the blocks neighboring the top.

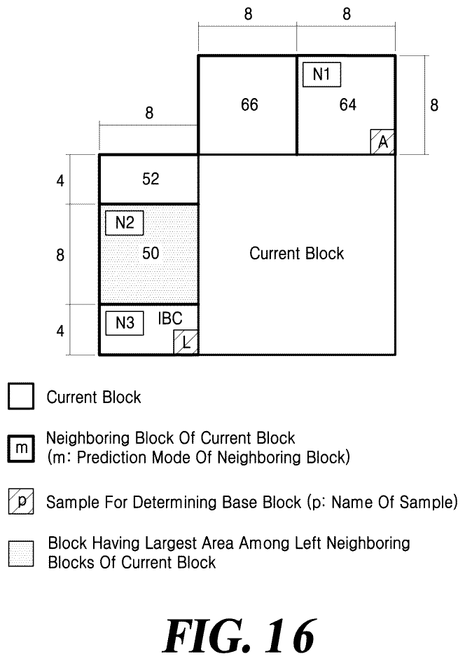

FIG. 16 is a diagram illustrating the switching of a base block by using areas, according to at least one embodiment of the present disclosure.

In one example case, as illustrated in FIG. 16, the prediction mode of a base block (a block including pixel L) adjacent to the left side of the current block is an irregular intra mode. The video decoding apparatus may search for a block with the largest area among the neighbor blocks adjacent to the left side of the current block and may switch the base block to the searched block, thereby turning the mode of the block to a regular intra-prediction mode. In the example of FIG. 16, since the mode of N3 block including pixel L is IBC, the video decoding apparatus searches for the block with the largest area among the neighbor blocks adjacent to the left of the current block. At this time, the video decoding apparatus switches the base block to N2 block because the area of N2 block is 64 which is the largest among the neighbor blocks adjacent to the left side of the current block, and the prediction mode of N2 block is mode 50 which is included in the set of regular intra-prediction modes. After the base block is switched to N2 block, the MPM list may be generated by using mode 50 which is the prediction mode of N2 block.

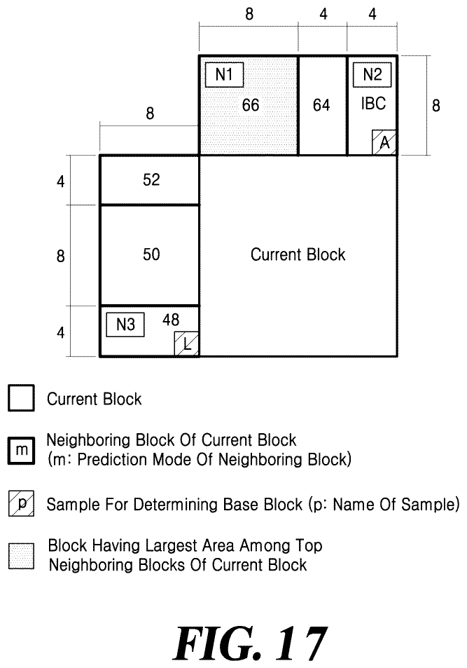

In another example case, as illustrated in FIG. 17, the prediction mode of the base block (the block including pixel A) adjacent to the top of the current block is an irregular intra mode. The video decoding apparatus may search for a block with the largest area among the neighbor blocks adjacent to the top of the current block and may switch the base block to the searched block, thereby turning the mode of the block into a regular intra-prediction mode. In the example of FIG. 17, since the mode of N2 block including pixel A is IBC, the video decoding apparatus searches for the block with the largest area among the neighbor blocks adjacent to the top of the current block. At this time, the video decoding apparatus switches the base block to N1 block because the area of N1 block is 64 which is the largest among the neighbor blocks adjacent to the top of the current block, and the prediction mode of N1 block is 66 which is included in the regular intra-prediction mode set. After the base block is switched to N1 block, the MPM list may be generated by using mode 66 which is the prediction mode of N1 block.

On the other hand, if two or more blocks have the same largest area, the base block may be selected to be one of the two or more blocks based on the preassigned priority, as in Implementation 1-2.

<Implementation 1-4> Method of Switching the Base Block to a Block Having a Regular Intra-Prediction Mode and Whose Aspect Ratio is Equal to (or Most Similar to) that of the Current Block Among Neighbor Blocks

In this implementation, the video decoding apparatus may switch the base block to a block having a regular intra-prediction mode and an aspect ratio that is the same as (or most similar to) that of the current block among the neighboring blocks of the current block. When switching the base block (the block including pixel L) adjacent to the left side of the current block, the video decoding apparatus may interchange the base block by searching the blocks neighboring the left side, and when switching the base block (the block including pixel A) adjacent to the top of the current block, the video decoding apparatus may interchange the base block by searching the blocks neighboring the top.

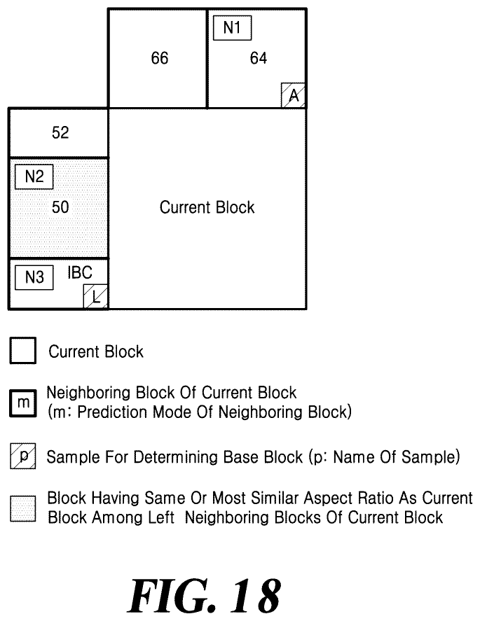

FIG. 18 is a diagram illustrating the switching of a base block by using aspect ratios, according to at least one embodiment of the present disclosure.

In one example case, as illustrated in FIG. 18, the prediction mode of a base block (a block including pixel L) adjacent to the left of the current block is an irregular intra mode. The video decoding apparatus may search for a block having an aspect ratio that is the same as (or most similar to) that of the current block among the neighbor blocks adjacent to the left of the current block, and may switch the base block to the searched block, thereby turning the mode of the block into a regular intra-prediction mode. In the example of FIG. 18, since the mode of N3 block including pixel L is IBC, the video decoding apparatus searches for a block whose aspect ratio is the same as (or most similar to) that of the current block among the neighbor blocks adjacent to the left of the current block. At this time, the video decoding apparatus switches the base block to N2 block because the aspect ratio of N2 block is the same as that of the current block among the neighbor blocks adjacent to the left of the current block, and the prediction mode of N2 block is mode 50 which is included in the regular intra-prediction mode set. After the base block is switched to N2 block, the MPM list may be generated by using mode 50 which is the prediction mode of N2 block.

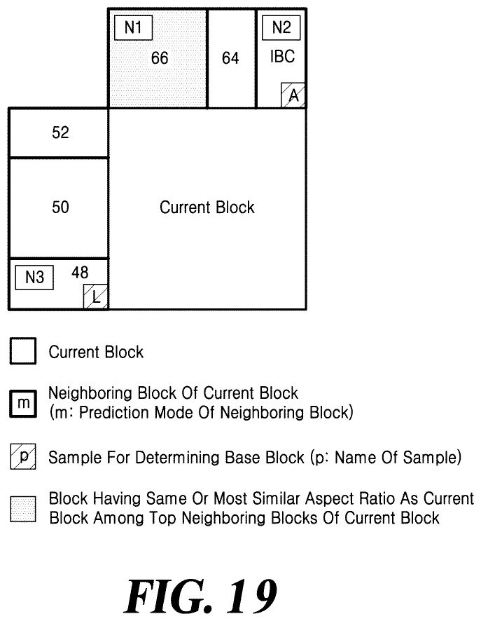

In another example case, as illustrated in FIG. 19, the prediction mode of the base block (the block including pixel A) adjacent to the top of the current block is an irregular intra mode. The video decoding apparatus may search for a block whose aspect ratio is the same as (or most similar to) that of the current block among the neighbor blocks adjacent to the top of the current block and may switch the base block to the searched block, thereby turning the mode of the block into a regular intra-prediction mode. In the example of FIG. 19, since the mode of N2 block including pixel A is IBC, the video decoding apparatus searches for a block whose aspect ratio is the same as (or most similar to) that of the current block among the neighbor blocks adjacent to the top of the current block. At this time, the video decoding apparatus switches the base block to N1 block because the aspect ratio of block N1 is the same as that of the current block among the neighbor blocks adjacent to the top of the current block, and the prediction mode of block N1 is mode 66 included in the set of regular intra-prediction modes. After the base block is switched to N1 block, the MPM list may be generated using mode 66 which is the prediction mode of N1 block.

On the other hand, if two or more blocks have the same (or most similar) aspect ratio as that of the current block, the base block may be selected to be one of the two or more blocks according to a preassigned priority, as in Implementation 1-2.

In addition to the above-described implementations of interchanging the base block by using the reconstructed information of the current block and its neighbors, the base block may be interchanged by using various other methods. For example, if the base block maintains an irregular intra mode even after the base block has been interchanged by using the above-described methods, the mode of the base block may be replaced with one of the existing regular intra-prediction modes. Further, the foregoing examples describe cases where the prediction mode of one of the two blocks including pixel L and pixel A is an irregular intra mode. However, when both blocks including pixel L and pixel A have an irregular intra mode, the base block replacement may still be made by extending the operations of the above examples.

### <Implementation 2> Determining the Applicability of the Present Disclosure and the Switching Method for the Base Block

In this implementation, the video decoding apparatus determines whether the present disclosure is to be applied and, if so, determines one of a plurality of base block switching methods. The determination of the applicability of the present disclosure may be based on information signaled from the video encoding apparatus. Alternatively, the video decoding apparatus may infer the applicability of the present disclosure. When the present disclosure applies, an index may be signaled from the video encoding apparatus, which indicates one of a plurality of base block switching methods according to Implementation 1. Alternatively, without separate signaling, the video decoding apparatus may determine the base block switching method as a predetermined method.

For example, a flag of adaptive_mpm_list_construction_enabled_flag may be used to signal the applicability of the present disclosure. When the present disclosure applies, one of a plurality of base block switching methods may be signaled by using the index adaptive_mpm_list_construction_idx.

The adaptive_mpm_list_construction_enabled_flag (‘adaptive MPM list generation flag’) indicates the applicability of the present disclosure. If the adaptive MPM list generation flag is true, the video decoding apparatus applies the present disclosure. On the other hand, if the adaptive MPM list generation flag is false, the video decoding apparatus chooses to not apply the present disclosure. If the present disclosure is not applied, the conventional method is used. If the prediction mode of the base block is an irregular intra mode, the video decoding apparatus would take the conventional method to replace the prediction mode of the base block with a mode included in the set of regular intra-prediction modes.

The adaptive_mpm_list_construction_idx (‘adaptive MPM list generation index’) indicates one of a plurality of switching methods for the base block. For example, based on the adaptive MPM list generation index, the base block switching methods may be classified as illustrated in Table 2.

TABLE 2

| adaptive_mpm_list_construction_idx | Switching method |
|---|---|
| 0 | Implementation 1-1 |
| 1 | Implementation 1-2 |
| 2 | Implementation 1-3 |
| 3 | Implementation 1-4 |

As described above, the applicability of the present disclosure may be determined based on the signaling of a flag or inference, and the switching method for the base block may be determined based on the signaling of an index or a preset method. Syntax associated with determining the applicability of the present disclosure and determining the base block switching method may be combined, for example, as shown in Table 3.

TABLE 3

| | adaptive_mpm_list_{—} | adaptive_mpm_list_{—} |
|---|---|---|
| | construction_enabled_flag | construction_idx |
| Implementation 2-1 | Signaling | Signaling |
| Implementation 2-2 | Signaling | Preset method |
| Implementation 2-3 | Inference | Signaling |
| Implementation 2-4 | Inference | Preset method |

Hereinafter, implementations for the combinations shown in Table 3 are each described in detail.

### <Implementation 2-1> Signaling Both the Applicability of the Present Disclosure and the Switching Method for the Base Block

In this implementation, the video decoding apparatus parses both the adaptive_mpm_list_construction_enabled_flag which determines the applicability of the present disclosure, and the adaptive_mpm_list_construction_idx which determines the switching method for the base block. The above-described information may be signaled at various levels, such as SPS/VPS/PPS/SH (slice header)/CTU (coding tree unit)/CU (coding unit), etc. As an example, when the applicability of the present disclosure and the switching method for the base block are signaled at the SPS level, the associated syntax may be represented as shown in Table 4.

TABLE 4
[SPS Level]

sps_adaptive_mpm_list_construction_enabled_flag
if (sps_adaptive_mpm_list_construction_enabled_flag)
sps_adaptive_mpm_list_construction_idx

In Table 4, the video decoding apparatus parses the sps_adaptive_mpm_list_construction_enabled_flag to determine the applicability of the present disclosure. If that flag is true, the video decoding apparatus parses sps_adaptive_mpm_list_construction_idx to determine the switching method for the base block. According to Table 4, coding efficiency can be increased because the applicability of the present disclosure and the switching method for the base block may be determined at once for lower levels such as CTUs and CUs by transmitting a smaller amount of information at the higher level.

As another example, the applicability of the present disclosure and the switching method for the base block may be signaled at the CU level, as shown in Table 5.

TABLE 5
[CU Level]

```
if (intra_luma_mpm_flag){
  intra_luma_not_planar_flag
  if(intra_luma_not_planar_flag) {
    adaptive_mpm_list_construction_enabled_flag
    if (adaptive_mpm_list_construction_enabled_flag)
      adaptive_mpm_list_construction_idx
    intra_luma_mpm_idx
  }
}
```

In Table 5, the video decoding apparatus parses the intra_luma_mpm_flag which indicates the use or non-use of a mode included in the MPM list on a per-CU basis. If intra_luma_mpm_flag is true, the video decoding apparatus parses intra_luma_not_planar_flag to determine whether the current CU is using planar mode. If intra_luma_not_planar_flag is true and the CU is using a mode in the MPM list other than planar mode, the video decoding apparatus parses both the flag that determines the applicability of the present disclosure and the index that determines the switching method for the base block. In this case, the applicability of the present disclosure and the base block switching method, which are appropriate may be adaptively signaled on a per-CU basis. On syntax, if both the intra_luma_mpm_flag and intra_luma_not_planar_flag are 1, additional information is signaled according to this implementation, which can avoid signaling additional information for all CUs at once.

As another example, as shown in Table 6, the applicability of this disclosure may be signaled at the SPS level and the switching method for the base block may be signaled at the CU level.

TABLE 6

```
[SPS Level]
sps_adaptive_mpm_list_construction_enabled_flag
[CU Level]
if (intra_luma_mpm_flag){
  intra_luma_not_planar_flag
  if(intra_luma_not_planar_flag) {
    if (sps_adaptive_mpm_list_construction_enabled_flag)
      adaptive_mpm_list_construction_idx
    intra_luma_mpm_idx
  }
}
```

In Table 6, the video decoding apparatus parses the sps_adaptive_mpm_list_construction_enabled_flag at the SPS level to determine the applicability of the present disclosure. Then, at the CU level, the video decoding apparatus parses the intra_luma_mpm_flag which indicates the use or non-use of the modes included in the MPM list on a per-CU basis. If intra_luma_mpm_flag is true, the video decoding apparatus parses intra_luma_not_planar_flag to determine whether the current CU is using planar mode. If the intra_luma_not_planar_flag is true and uses a mode in the MPM list other than planar mode, the video decoding apparatus checks the applicability of the present disclosure determined at a higher level. When the present disclosure applies, the video decoding apparatus parses the index that indicates the switching method for the base block.

According to Table 6, coding efficiency can be increased because the applicability of the present disclosure may be determined at once for lower levels such as CTUs and CUs without additional information transfer at the higher level. Further, the appropriate base block switching method may be adaptively signaled on a per-CU basis. Table 6 shows an example where the applicability of the present disclosure is signaled at the SPS level and the base block switching method is signaled at the CU level, but in various other combinations, the applicability of the present disclosure may be signaled at a higher level and the base block switching method may be signaled at a lower level than the higher level.

### <Implementation 2-2> Signaling the Applicability of the Present Disclosure, and Determining the Base Block Switching Method as a Preset Method

In this implementation, the video decoding apparatus parses the adaptive_mpm_list_construction_enabled_flag that determines the applicability of the present disclosure and determines the base block switching method as the preset method. The flag determining the applicability of the present disclosure may be signaled at various levels, such as SPS/VPS/PPS/SH (slice header)/CTU (coding tree unit)/CU (coding unit), or the like. Accordingly, no additional information is transmitted to determine the switching method for the base block, which can increase coding efficiency.

In one example, the applicability of the present disclosure may be signaled at the SPS level, as shown in Table 7.

TABLE 7
[SPS Level]

sps_adaptive_mpm_list_construction_enabled_flag

In Table 7, the video decoding apparatus parses the sps_adaptive_mpm_list_construction_enabled_flag to determine the applicability of the present disclosure. If this flag is true, the video decoding apparatus determines the base block switching method to be the preset method. According to Table 7, the applicability of the present disclosure may be determined at once for lower levels such as CTUs and CUs with only a small amount of bits at the higher level, which can increase coding efficiency.

As another example, the applicability of the present disclosure may be signaled at the CU level, as shown in Table 8.

TABLE 8
[CU Level]

```
if (intra_luma_mpm_flag){
  intra_luma_not_planar_flag
  if(intra_luma_not_planar_flag) {
    adaptive_mpm_list_construction_enabled_flag
    intra_luma_mpm_idx
  }
}
```

In Table 8, the video decoding apparatus parses on a per-CU basis the intra_luma_mpm_flag, which indicates whether the CU is using a mode included in the MPM list. If intra_luma_mpm_flag is true, the video decoding apparatus parses intra_luma_not_planar_flag to determine whether the current CU is using planar mode. If intra_luma_not_planar_flag is true and the CU is using a mode in the MPM list other than planar mode, the video decoding apparatus parses the flag to determine the applicability of the present disclosure. In this case, the applicability of the present disclosure that is appropriate may be adaptively signaled on a per-CU basis. On syntax, if both intra_luma_mpm_flag and intra_luma_not_planar_flag are 1, additional information is signaled according to this implementation, which can avoid signaling additional information for all CUs at once.

### <Implementation 2-3> Inferring the Applicability of the Present Disclosure, and Signaling the Switching Method for the Base Block

In this implementation, the video decoding apparatus uses high-level information to the of the present disclosure and infer applicability parses the adaptive_mpm_list_construction_idx that determines the switching method for the base block. The index that determines the switching method for the base block may be signaled at various levels, such as SPS/VPS/PPS/SH (slice header)/CTU (coding tree unit)/CU (coding unit), or the like.

To determine the applicability of the present disclosure, the video decoding apparatus may consider the following high-level information The video decoding apparatus may consider the information of a type of video, such as natural content (NC), screen content (SC), light field content, XR content, point cloud content, or the like. In addition, the video decoding apparatus may consider information about whether a compression technique is to be allowed, such as sps_ibc_enabled_flag, sps_palette_enabled_flag, sps_bdpcm_enabled_flag, sps_mip_enabled_flag, and the like.

Depending on the video type, additional prediction techniques are allowed, which are included in the set of irregular intra-modes, such as IBC, palette, BDPCM, MIP, or the like. Due to the frequent use of these modes, it may be inefficient to simply replace an irregular intra mode with one of the regular intra-prediction modes, as is done with conventional MPM techniques. Accordingly, based on high-level information such as the type of video, additionally allowed prediction techniques, and the like, the video decoding apparatus may infer the applicability of the present disclosure. Namely, based on the high-level information, it may be predetermined whether the application of the present disclosure is advantageous. In this case, no additional information is transmitted, which can increase coding efficiency.

In the following, methods for considering the above-mentioned high-level information are described in detail.

The first case is where there is a high-level syntax (sps_video_type) that determines a video type. If the video type is NC (sps_video_type=0), the video decoding apparatus infers the adaptive_mpm_list_construction_enabled_flag to be false. Additionally, if the video type is SC (sps_video_type=1), the video decoding apparatus may infer adaptive_mpm_list_construction_enabled_flag to be true.

In one example, the applicability of this disclosure may be inferred based on the video type at the SPS level, as shown in Table 9, and a base block switching method may be signaled accordingly.

TABLE 9
[SPS Level]

```
sps_video_type
if (sps_video_type==0)
  sps_adaptive_mpm_list_construction_enabled_flag=0
else
  sps_adaptive_mpm_list_construction_enabled_flag=1
if (sps_adaptive_mpm_list_construction_enabled_flag)
  sps_adaptive_mpm_list_construction_idx
```

In Table 9, the video decoding apparatus parses sps_video_type to determine the video type and then infers the applicability of the present disclosure based on the video type. When the present disclosure applies, the video decoding apparatus further parses sps_adaptive_mpm_list_construction_idx to determine the switching method for the base block. According to Table 9, coding efficiency can be increased because the applicability of the present disclosure may be determined at once for lower levels such as CTUs, CUs, or the like. without additional information transfer in the higher level, and the base block switching method may be determined at once for lower levels such as CTUs, CUs, or the like with only a small amount of bits.

As another example shown in Table 10, the applicability of the present disclosure may be inferred according to the video type at the SPS level, and the base block switching method may be signaled at the CU level.

TABLE 10

```
[SPS Level]
sps_video_type
if (sps_video_type==0)
  sps_adaptive_mpm_list_construction_enabled_flag=0
else
  sps_adaptive_mpm_list_construction_enabled_flag=1
[CU Level]
if (intra_luma_mpm_flag){
  intra_luma_not_planar_flag
  if(intra_luma_not_planar_flag) {
    if (sps_adaptive_mpm_list_construction_enabled_flag)
      adaptive_mpm_list_construction idx
    intra_luma_mpm_idx
  }
}
```

In Table 10, the video decoding apparatus parses sps_video_type at the SPS level to determine the video type and infers the applicability of the present disclosure based on the video type. When the present disclosure applies, the video decoding apparatus parses the intra_luma_mpm_flag at the CU level, which indicates the use or non-use of modes included in the MPM list on a per-CU basis. If intra_luma_mpm_flag is true, the video decoding apparatus parses intra_luma_not_planar_flag to determine whether the current CU is using planar mode. If the intra_luma_not_planar_flag is true and uses a mode in the MPM list other than planar mode, the video decoding apparatus checks the applicability of the present disclosure determined at a higher level. When the present disclosure applies, the video decoding apparatus parses the index adaptive_mpm_list_construction_idx which indicates the switching method for the base block.

According to Table 10, coding efficiency can be increased because the applicability of the present disclosure is inferred without additional information transfer at a higher level. Furthermore, when the present disclosure applies, the appropriate base block switching method may be adaptively signaled on a per-CU basis. On syntax, if both the intra_luma_mpm_flag and intra_luma_not_planar_flag are 1, additional information is signaled according to this implementation, which avoids signaling additional information for all CUs at once. Table 10 shows an example where the applicability of this disclosure is inferred at the SPS level and the base block switching method is signaled at the CU level, but in various other combinations, the applicability of this disclosure may be inferred by using higher-level information and the base block switching method may be signaled at a lower level than the higher level.

The second case is where, if at least one of the prediction techniques corresponding to the irregular intra mode is admissible according to the compression technique admissibility information, the video decoding apparatus may infer adaptive_mpm_list_construction_enabled_flag to be true. Whereas if none of the prediction techniques corresponding to irregular intra mode is permitted, the video decoding apparatus may infer adaptive_mpm_list_construction_enabled_flag to be false.

In one example, the applicability of the present disclosure may be inferred based on the compression technique admissibility information at the SPS level, as shown in Table 11, and a switching method for the base block may be signaled accordingly.

TABLE 11
[SPS Level]

```
if (sps_ibc_enabled_flag || sps_palette_enabled_flag
  || sps_bdpcm_enabled_flag || sps_mip_enabled_flag)
  sps_adaptive_mpm_list_construction_enabled_flag=1
else
  sps_adaptive_mpm_list_construction_enabled_flag=0
if (sps_adaptive_mpm_list_construction_enabled_flag)
  sps_adaptive_mpm_list_construction_idx
```

In Table 11, the video decoding apparatus parses the admissibility of the compression technique corresponding to an irregular intra mode to determine whether it is admissible and then infers the applicability of the present disclosure based on whether the compression technique is admissible. When the present disclosure applies, the video decoding apparatus further parses the sps_adaptive_mpm_list_construction_idx to determine the switching method for the base block. According to Table 11, coding efficiency can be increased because the applicability of the present disclosure may be determined at once for lower levels of CTUs, CUs, and the like without additional information transmission at the higher level, and the base block switching method may be determined at once for lower levels of CTUs, CUs, and the like with only a small amount of bits.

As another example shown in Table 12, the applicability of the present disclosure may be inferred at the SPS level based on the admissibility of the compression technique, and the base block switching method may be signaled at the CU level.

TABLE 12

```
[SPS Level]
if (sps_ibc_enabled_flag || sps_palette_enabled_flag
  || sps_bdpcm_enabled_flag || sps_mip_enabled_flag)
  sps_adaptive_mpm_list_construction_enabled_flag=1
else
  sps_adaptive_mpm_list_construction_enabled_flag=0
[CU Level]
if (intra_luma_mpm_flag){
  intra_luma_not_planar_flag
  if(intra_luma_not planar_flag) {
    if (sps_adaptive_mpm_list_construction_enabled_flag)
      adaptive_mpm_list_construction_idx
    intra_luma_mpm_idx
  }
}
```

In Table 12, the video decoding apparatus parses at the SPS level the admissibility of the compression technique corresponding to an irregular intra mode to determine whether it is admissible and then infers the applicability of the present disclosure based on the admissibility of the compression technique. When the present disclosure applies, the video decoding apparatus parses at the CU level the intra_luma_mpm_flag which indicates the use or non-use of the mode included in the MPM list on a per-CU basis. If intra_luma_mpm_flag is true, the video decoding apparatus parses intra_luma_not_planar_flag to determine whether the current CU is using planar mode. If intra_luma_not_planar_flag is true and the current CU is using a mode in the MPM list other than planar mode, the video decoding apparatus may confirm the applicability of the present disclosure, as determined at a higher level. When the present disclosure applies, the video decoding apparatus parses the index adaptive_mpm_list_construction_idx which indicates the switching method for the base block.

According to Table 12, coding efficiency can be increased because the applicability of the present disclosure is inferred without an additional information transmission at a higher level. Further, when the present disclosure applies, the appropriate base block switching method may be adaptively signaled on a per-CU basis. On syntax, if both intra_luma_mpm_flag and intra_luma_not_planar_flag are 1, additional information is signaled according to this implementation, thus avoiding signaling additional information for all CUs at once. Table 12 shows an example where the applicability of this disclosure is inferred at the SPS level and the base block switching method is signaled at the CU level, but in various other combinations, the applicability of this disclosure may be inferred by using higher-level information and the base block switching method may be signaled at a lower level than the higher level.

### <Implementation 2-4> Inferring the Applicability of the Present Disclosure and Determining the Base Block Switching Method as a Preset Method

In this implementation, the video decoding apparatus uses high-level information to infer the applicability of the present disclosure and determines the base block switching method as a preset method. In determining the applicability of the present disclosure, the same high-level information exemplified in Implementation 2-3 may be considered. Accordingly, a determination may be made in advance on whether it is advantageous to apply the present disclosure based on the same high-level information as in Implementation 2-3. Thus, coding efficiency can be increased because no additional information is transmitted to determine the applicability of the present disclosure.

Methods for considering high-level information, such as exemplified in Implementation 2-3, are described in detail.

In the first case, there is a high-level syntax (sps_video_type) that determines the type of video. If the video type is NC (sps_video_type=0), the video decoding apparatus infers the adaptive_mpm_list_construction_enabled_flag to be false. Additionally, if the video type is SC (sps_video_type=1), the video decoding apparatus may infer adaptive_mpm_list_construction_enabled_flag to be true.

In one example shown in Table 13, the applicability of the present disclosure may be inferred based on the video type at the SPS level, and the base block switching method may be determined to be a preset method accordingly.

TABLE 13
[SPS Level]

```
sps_video_type
if (sps_video_type==0)
  sps_adaptive_mpm_list_construction_enabled_flag=0
else
  sps_adaptive_mpm_list_construction_enabled_flag=1
```

In Table 13, the video decoding apparatus parses sps_video_type at the SPS level to determine the video type and infers the applicability of the present disclosure based on the video type. When the present disclosure applies, the video decoding apparatus determines the base block switching method as the preset method. According to Table 13, the applicability of the present disclosure and the base block switching may be determined at once for lower levels such as CTUs and CUs without additional information transmission at a higher level, thereby increasing coding efficiency.

The second case is where, if at least one of the prediction techniques corresponding to an irregular intra mode is admissible according to the compression technique admissibility information, the video decoding apparatus may infer the adaptive_mpm_list_construction_enabled_flag to be true. Whereas if none of the prediction techniques corresponding to an irregular intra mode is admissible, the video decoding apparatus may infer the adaptive_mpm_list_construction_enabled_flag to be 0.

In one example shown in Table 14, the applicability of the present disclosure may be inferred based on the compression technique admissibility information at the SPS level, and the base block switching method may be determined to be the preset method.

TABLE 14
[SPS Level]

```
if (sps_ibc_enabled_flag || sps_palette_enabled_flag
  || sps_bdpcm_enabled_flag || sps_mip_enabled_flag)
  sps_adaptive_mpm_list_construction_enabled_flag=1
else
  sps_adaptive_mpm_list_construction_enabled_flag=0
```

In Table 14, the video decoding apparatus parses the admissibility of the compression technique corresponding to an irregular intra mode to determine whether it is admissible and then infers the applicability of the present disclosure based on the admissibility of the compression technique. When the present disclosure applies, the video decoding apparatus determines the base block switching method to be the preset method. According to Table 14, the applicability of the present disclosure and the base block switching may be determined at once for lower levels such as CTUs and CUs without additional information transmission from a higher level, thereby increasing coding efficiency.

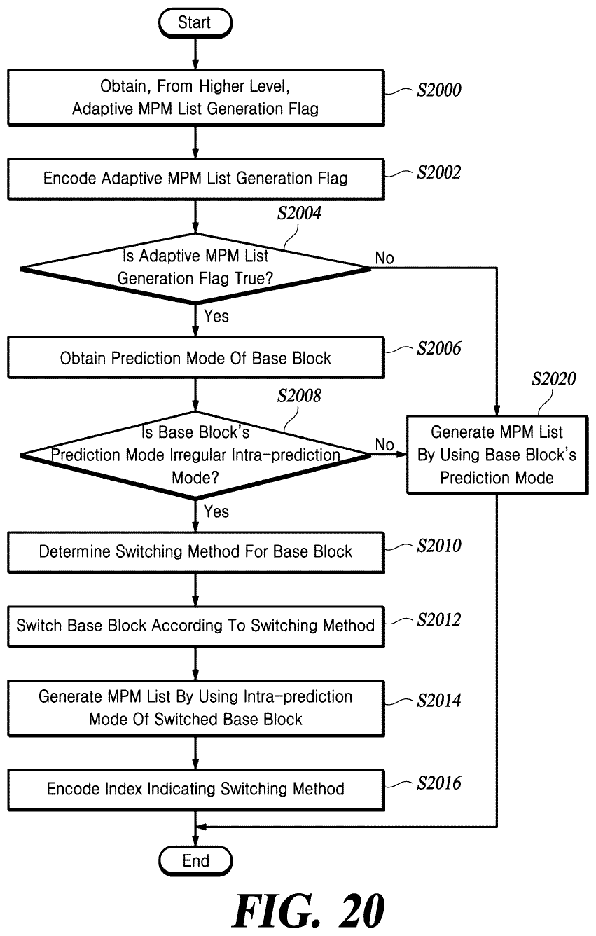

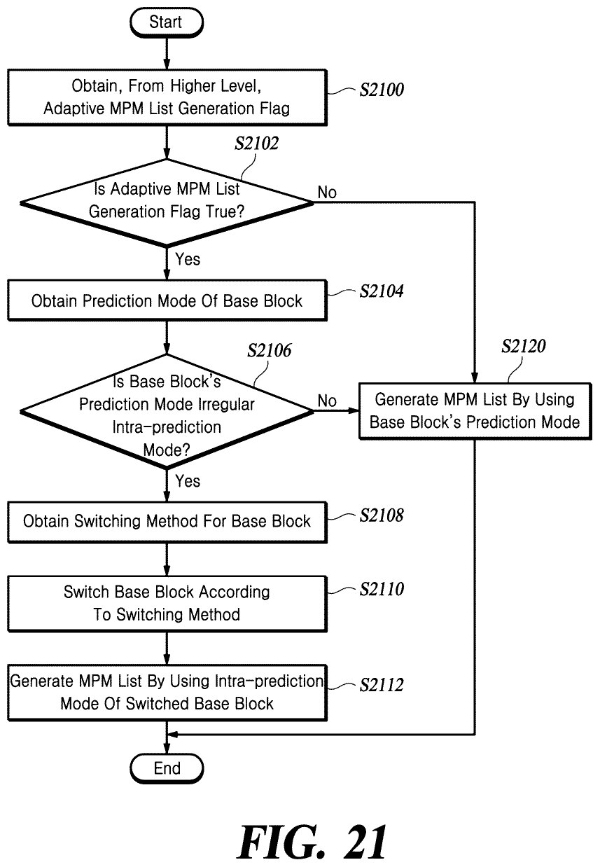

Referring now to FIGS. 20 and 21, the following describes methods of generating an MPM list based on a base block that has been switched according to settings at a higher level. The illustrations of FIGS. 20 and 21 may be equivalent to Table 4/Table 6 of Implementation 2-1, Table 7 of Implementation 2-2, Implementation 2-3, and Implementation 2-4.

FIG. 20 is a flowchart of a method of encoding the current block by the video encoding apparatus, according to at least one embodiment of the present disclosure.

The video encoding apparatus obtains an adaptive MPM list generation flag from a higher level (S2000). Here, the adaptive MPM list generation flag indicates whether an MPM list is to be generated based on a switching of the base block. In terms of rate-distortion optimization, the video encoding apparatus may determine the adaptive MPM list generation flag at a higher level. Alternatively, the video encoding apparatus may use the high-level information to derive the adaptive MPM list generation flag at a higher level. Here, the high-level information may be the type of video or the information on the admissibility of the prediction technique utilizing irregular intra mode.

The base block may be a block including a pixel located on the left of the bottom-left pixel of the current block or a block including a pixel located on the top of the top-right pixel of the current block.

The video encoding apparatus encodes the adaptive MPM list generation flag (S2002).

The video encoding apparatus checks the adaptive MPM list generation flag (S2004).

If the adaptive MPM list generation flag is true (Yes in S2004), the video encoding apparatus performs the following steps.

The video encoding apparatus obtains the prediction mode of the base block of the current block (S2006).

The video encoding apparatus checks the prediction mode of the base block (S2008).

If the prediction mode of the base block is an irregular intra mode (Yes in S2008), the video encoding apparatus performs the following steps.

The video encoding apparatus determines the switching method for the base block (S2010).

The video encoding apparatus may determine the switching method for the base block in terms of optimizing the rate distortion. Alternatively, the video encoding apparatus may set the switching method for the base block to a preset method. The switching method for the base block may be one of the methods exemplified in Implementation 1.

The video encoding apparatus switches the base block to a block having a regular intra-prediction mode according to the switching method (S2012).

The video encoding apparatus generates an MPM list of the current block by using the intra-prediction mode of the switched base block (S2014).

If a switching method for the base block has been determined in terms of rate distortion optimization, the video encoding apparatus encodes an index indicating the switching method (S2016).

If the adaptive MPM list generation flag is false (No in S2004), the video encoding apparatus generates the MPM list by using the prediction mode of the base block (S2020).

Further, if the prediction mode of the base block is not an irregular intra mode (No in S2008), the video encoding apparatus generates the MPM list by using the prediction mode of the base block (S2020).

The video encoding apparatus may then generate a prediction block of the current block by using an intra-prediction mode determined from the MPM list, and may encode an MPM index indicative of the determined intra-prediction mode.

FIG. 21 is a flowchart of a method of reconstructing the current block by the video decoding apparatus, according to at least one embodiment of the present disclosure.

The video decoding apparatus obtains an adaptive MPM list generation flag from a higher level (S2100). Here, the adaptive MPM list generation flag indicates whether an MPM list is to be generated in response to a switching of the base block. The video decoding apparatus may decode the adaptive MPM list generation flag from the bitstream at a higher level. Alternatively, the video decoding apparatus may use the high-level information to derive the adaptive MPM list generation flag from the high level. Here, the high-level information may be the type of video or the information on the admissibility of the prediction technique utilizing an irregular intra mode.

The base block may be a block including a pixel located on the left of the bottom-left pixel of the current block or a block including a pixel located on the top of the top-right pixel of the current block.

The video decoding apparatus checks the adaptive MPM list generation flag (S2102).

If the adaptive MPM list generation flag is true (Yes in S2102), the video decoding apparatus performs the following steps.

The video decoding apparatus obtains the prediction mode of the base block of the current block (S2104).

The video decoding apparatus checks the prediction mode of the base block (S2106).

If the prediction mode of the base block is an irregular intra mode (Yes in S2106), the video decoding apparatus performs the following steps.

The video decoding apparatus obtains the switching method for the base block (S2108).

The video decoding apparatus may decode the switching method for the base block from the bitstream. Alternatively, the video decoding apparatus may set the switching method for the base block to a preset method. The switching method for the base block may be one of the methods exemplified in Implementation 1.

The video decoding apparatus switches the base block to a block having a regular intra-prediction mode according to the switching method (S2110).

The video decoding apparatus generates an MPM list of the current block by using the intra-prediction mode of the switched base block (S2112).

On the other hand, if the adaptive MPM list generation flag is false (No in S2102), the video decoding apparatus generates the MPM list by using the prediction mode of the base block (S2120).

Further, if the prediction mode of the base block is not an irregular intra mode (No in S2106), the video decoding apparatus generates the MPM list by using the prediction mode of the base block (S2120).

Thereafter, the video decoding apparatus may decode the MPM index from the bitstream and may generate the prediction block of the current block by using the intra-prediction mode determined from the MPM list according to the MPM index.

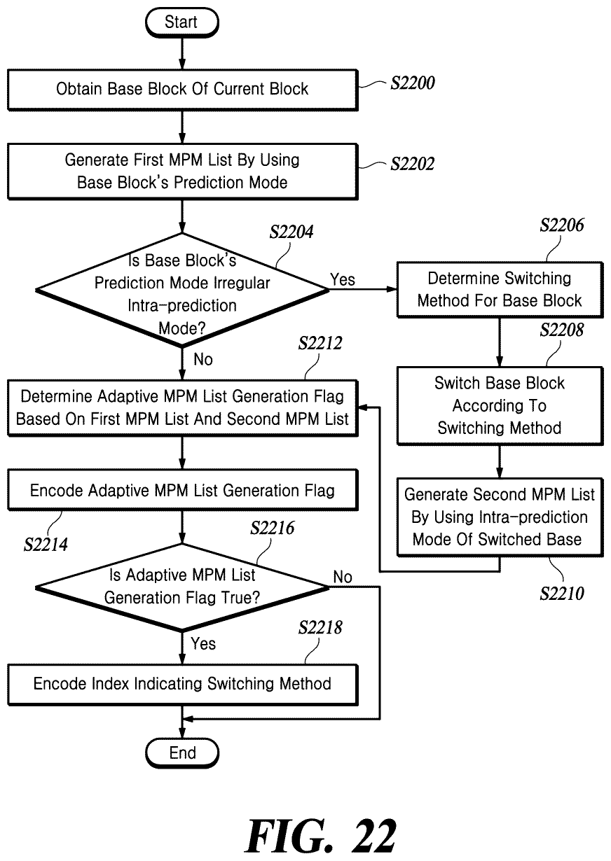

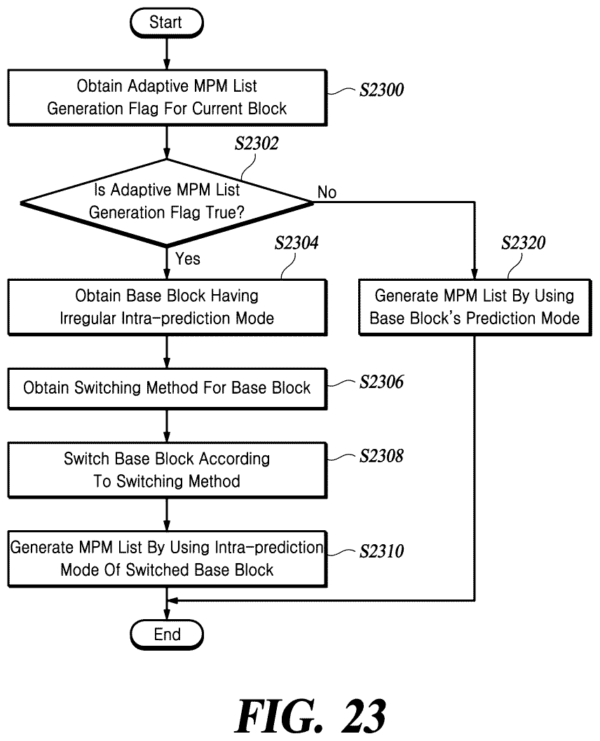

Referring to FIGS. 22 and 23, the following describes methods of generating an MPM list based on a base block switched according to a per-CU setting. The illustrations of FIGS. 22 and 23 may be equivalent to Table 5 of Implementation 2-1 and Table 8 of Implementation 2-2.

FIG. 22 is a flowchart of a method of encoding the current block by the video encoding apparatus, according to another embodiment of the present disclosure.

The video encoding apparatus obtains a base block of the current block (S2200). Here, the base block may be a block including a pixel on the left of a bottom-left pixel of the current block or a block including a pixel on the top of a top-right pixel of the current block.

The video encoding apparatus generates a first MPM list of the current block by using the prediction mode of the base block (S2202).

The video encoding apparatus checks the prediction mode of the base block (S2204).

If the prediction mode of the base block is an irregular intra mode (Yes in S2204), the video encoding apparatus performs the following steps.

The video encoding apparatus determines the switching method for the base block (S2206).

In terms of rate distortion optimization, the video encoding apparatus may determine the switching method for the base block. Alternatively, the video encoding apparatus may set the switching method for the base block to a preset method. The switching method for the base block may be one of the methods exemplified in Implementation 1.

The video encoding apparatus switches the base block to a block having a regular intra-prediction mode according to the switching method (S2208).

The video encoding apparatus generates a second MPM list of the current block by using the intra-prediction mode of the switched base block (S2210).

On the other hand, if the prediction mode of the base block is not an irregular intra mode (No in S2204), the above-described steps of generating the second MPM list may be omitted.

The video encoding apparatus determines an adaptive MPM list generation flag based on the first MPM list and the second MPM list (S2212). Here, the adaptive MPM list generation flag indicates whether the second MPM list is to be generated in response to a switching of the base block. In terms of rate distortion optimization, the video encoding apparatus may determine the adaptive MPM list generation flag on a CU-by-CU basis. For example, if the first MPM list is optimal, the adaptive MPM list generation flag may be determined to be false. On the other hand, if the second MPM list is optimal, the adaptive MPM list generation flag may be determined to be true. Further, if the second MPM list is not generated, the adaptive MPM list generation flag may be determined to be false.

The video encoding apparatus encodes the adaptive MPM list generation flag (S2214).

The video encoding apparatus checks the adaptive MPM list generation flag (S2216).

If the adaptive MPM list generation flag is true (Yes in S2216) and the switching method for the base block is determined in terms of rate distortion optimization, the video encoding apparatus encodes an index indicating the switching method for the base block (S2218).

The video encoding apparatus may then generate a prediction block of the current block by using an intra-prediction mode determined from the MPM list, and may encode an MPM index indicating the determined intra-prediction mode.

FIG. 23 is a flowchart of a method of reconstructing the current block by the video decoding apparatus, according to another embodiment of the present disclosure.

The video decoding apparatus obtains an adaptive MPM list generation flag for the current block (S2300). Here, the adaptive MPM list generation flag indicates whether an MPM list is to be generated in response to a switching of the base block. The base block may be a block including a pixel on the left of a bottom-left pixel of the current block or a block including a pixel on the top of a top-right pixel of the current block.

The video decoding apparatus checks the adaptive MPM list generation flag (S2302).

If the adaptive MPM list generation flag is true (Yes in S2302), the video decoding apparatus performs the following steps.

The video decoding apparatus obtains a base block having an irregular intra mode (S2304). Since the per-CU adaptive MPM list generation flag is true, a base block having an irregular intra mode may be obtained for the current block.

The video decoding apparatus obtains a switching method for the base block (S2306).

The video decoding apparatus may decode the switching method for the base block from the bitstream. Alternatively, the video decoding apparatus may set the switching method for the base block to a preset method. The switching method for the base block may be one of the methods exemplified in Implementation 1.

The video decoding apparatus switches the base block to a block having a regular intra-prediction mode according to the switching method (S2308).

The video decoding apparatus generates an MPM list of the current block by using the intra-prediction mode of the switched base block (S2310).

On the other hand, if the adaptive MPM list generation flag is false (No in S2302), the video decoding apparatus generates the MPM list by using the prediction mode of the base block (S2320).

Thereafter, the video decoding apparatus may decode the MPM index from the bitstream and may generate a prediction block of the current block by using an intra-prediction mode determined from the MPM list based on the MPM index.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

122: intra predictor
155: entropy encoder
510: entropy decoder
542: intra predictor

### CROSS-REFERENCE TO RELATED APPLICATIONS

This application claims priority to and the benefit of Korean Patent Application No. 10-2022-0168825 filed on Dec. 6, 2022, and Korean Patent Application No. 10-2023-0143180, filed on Oct. 24, 2023, the entire contents of each of which are incorporated herein by reference.

1. A method of reconstructing a current block by a video decoding apparatus, the method comprising:
obtaining a prediction mode of a base block of the current block, wherein the base block is a block comprising pixels positioned to a left side of a bottom-left pixel of the current block or a block comprising pixels positioned to a top side of a top-right pixel of the current block; and
checking the prediction mode of the base block,
wherein, when the prediction mode of the base block is an irregular intra mode, the method further comprises:
obtaining a switching method for the base block;
switching the base block to a block having a regular intra-prediction mode according to the switching method; and
generating a most probable mode list (MPM list) of the current block by using the regular intra-prediction mode of a switched base block.

2. The method of claim 1, wherein the switching method comprises:
searching neighboring pixels of the current block according to a predetermined searching order, excluding pixels included in the base block; and
switching the base block to a block including a first pixel predicted according to the regular intra-prediction mode.

3. The method of claim 1, wherein the switching method comprises:
searching for blocks having the regular intra-prediction mode on a side with the base block; and
switching the base block to a block having a longest length of adjacency to the current block among searched blocks.

4. The method of claim 1, wherein the switching method comprises:
searching for blocks having the regular intra-prediction mode on a side with the base block; and
switching the base block to a block having a largest area among searched blocks.

5. The method of claim 1, wherein the switching method comprises:
searching for blocks having the regular intra-prediction mode on a side with the base block; and
switching the base block to a block whose aspect ratio among searched blocks is equal to or most similar to an aspect ratio of the current block.

6. The method of claim 1, wherein obtaining the switching method comprises:
decoding an index that indicates a switching method from a bitstream; and
setting the switching method to a method that is indicated by the index.

7. The method of claim 1, wherein obtaining the switching method comprises:
setting the switching method to a preset switching method.

8. The method of claim 1, further comprising:
obtaining an adaptive MPM list generation flag that indicates whether the MPM list is to be generated in response to the switching of the base block; and
checking the adaptive MPM list generation flag,
wherein, when the adaptive MPM list generation flag is true, the method further comprises:
obtaining the base block and checking the prediction mode of the base block.

9. The method of claim 8, further comprising, when the adaptive MPM list generation flag is false:
generating the MPM list by using the prediction mode of the base block.

10. The method of claim 8, wherein the obtaining of the adaptive MPM list generation flag comprises:
decoding the adaptive MPM list generation flag from a bitstream.

11. The method of claim 8, wherein obtaining the adaptive MPM list generation flag comprises:
deriving the adaptive MPM list generation flag by using high-level information that is a type of video or information on an admissibility of a prediction technique using the irregular intra mode.

12. The method of claim 1, further comprising, when the prediction mode of the base block is not the irregular intra mode:
generating the MPM list by using the prediction mode of the base block.

13. The method of claim 1, wherein the irregular intra mode is a prediction mode other than the regular intra-prediction mode that comprises a non-angular prediction mode, including a planar mode and a DC mode, and an angular prediction mode.

14. A method of encoding a current block by a video encoding apparatus, the method comprising:
obtaining a prediction mode of a base block of the current block, wherein the base block is a block comprising pixels positioned to a left side of a bottom-left pixel of the current block or a block comprising pixels positioned to a top side of a top-right pixel of the current block; and
checking the prediction mode of the base block,
wherein, when the prediction mode of the base block is an irregular intra mode, the method further comprises:
determining a switching method for the base block;
switching the base block to a block having a regular intra-prediction mode according to the switching method; and
generating a most probable mode list (MPM list) of the current block by using the regular intra-prediction mode of a switched base block.

15. The method of claim 14, further comprising:
obtaining, from a higher level, an adaptive MPM list generation flag that indicates whether the MPM list is to be generated in response to the switching of the base block; and
encoding the adaptive MPM list generation flag.

16. The method of claim 15, further comprising:
checking the adaptive MPM list generation flag,
wherein, when the adaptive MPM list generation flag is true, the method further comprises:
obtaining the prediction mode of the base block and checking the prediction mode of the base block.

17. The method of claim 14, further comprising:
encoding an index indicating the switching method when the prediction mode of the base block is the irregular intra mode and the switching method is determined in terms of rate distortion optimization.

18. A computer-readable recording medium storing a bitstream generated by a video encoding method, the video encoding method comprises:
obtaining a prediction mode of a base block of a current block, wherein the base block is a block comprising pixels positioned to a left side of a bottom-left pixel of the current block or a block comprising pixels positioned to a top side of a top-right pixel of the current block; and
checking the prediction mode of the base block,
wherein, when the prediction mode of the base block is an irregular intra mode, the video encoding method further comprises:
determining a switching method for the base block;
switching the base block to a block having a regular intra-prediction mode according to the switching method; and
generating a most probable mode list (MPM list) of the current block by using the regular intra-prediction mode of a switched base block.
